(19) United States
(12) Patent Application Publication
(10) Pub. No.: US 2014/0123176 A1
(43) Pub. Date: May 1, 2014

(54) Direct Marketing Interface for Network Television

(71) Applicant: Robin Ross Cooper, La Mesa, CA (US)

(72) Inventor: Robin Ross Cooper, La Mesa, CA (US)

(21) Appl. No.: 14/069,078

(22) Filed: Oct. 31, 2013

Related U.S. Application Data
(60) Provisional application No. 61/720,898, filed on Oct. 31, 2012.

(51) Int. Cl. H04N 21/2668; H04N 21/81

(52) U.S. Cl. CPC H04N 21/2668; H04N 21/812
USPC 725/34

(57) ABSTRACT

A method of communicating targeted advertising to media reception devices of individual consumers, receiving electronic signals of said media from broadcasters through communication to a local system provider such as a cable or satellite television system provider. The system allows a single broadcaster to disseminate targeted advertising throughout multiple connected system providers to allow centralized target marketing to consumers.

This application is a nonprovisional application of U.S. Provisional Application No. 61/720,898 filed on Oct. 31, 2012, and is included herein in its entirety with this reference thereto.

### BACKGROUND OF THE INVENTION

1. Field of the Invention

The present invention relates to a system and method for distributing targeted digital advertising content. More particularly, it relates to a system and method wherein digital video advertising content is ordered from direct marketing organizations through broadcaster's television networks and the advertisements from the ordered content s then communicated to television signal systems operators or distributors, such as cable or satellite television systems, who communicate digital media through their system, to the target subscribing viewers on their system for delivery of chosen advertisements to identified individual and groups of subscribers receiving their television and streaming media from the respective system.

2. Prior Art

In recent years in the broadcast media industry it is well known that vendors of targeted advertising systems for television viewers, have focused their attention for distribution of advertising media through the operator rather than the broadcaster. For example, a advertising vendor might focus the development of their software system to be relevant to a signal provider to viewers such as COMCAST (the operator) rather than being relevant to an original broadcaster such as Fox Network which originates television broadcasts and provides the signal to the operators such as cable and satellite systems, to subscribing viewers. Cable and satellite signal providers to viewers however are just individual points for the distribution of Direct Marketing Advertising providing digital signals to their respective group or segment of viewers who happen to be subscribers to the system. Such a single segmentized point of advertising distribution is not satisfactory to deliver targeted ads to the millions of individual targeted viewers from manufactured “lists” since they become segmentized in regional groups by the fact that they receive the broadcast and streaming signal from a regional provider. This segmenting of viewers requires firms interested in delivering ads to lists containing viewers nationally located, to deal with multiple individual cable and satellite operators, to deliver the ads. Further it forces the firm wishing to advertise, to do extensive work in sorting the nationalized list of consumers, into segmented lists for provision to the various regional operators, to then deliver the targeted advertising to their identified individual subscribers. The need to sort and discern sub lists from national lists and work through multiple system providers to deliver advertising is more expensive, time consuming, and a logistical nightmare when the advertising must be timed for delivery to the viewers to provide a marketing campaign concurrent advertising to the targeted viewers during a certain daily, weekly, or monthly time period. Consequently the current system inhibits such advertising campaigns and sales of such advertising due to the logistics involved and routing national lists of potential customers through a plurality of different system providers and doing so to meet each provider's needs for lead time to deliver the advertising in the desired week or month.

Broadcasters who originate media broadcasts such as FOX network, already communicate electronic digital media such as TV series, movies, streaming video, and other media, to many different cable and satellite systems operators such as COMCAST, DIRECTV, TIME WARNER and the like. These broadcasters thus already provide such digital media to the large plurality of systems operators and are well versed in dealing with the communication and timing requirements of each of them. Consequently, the broadcasters are in a much better position to fulfill the targeted advertising needs of Direct Marketing Organizations who currently must deal with dozens of different system providers who provide digital media to subscribers.

Recently, numerous companies have become involved in the substitution of generalized advertisements for more relevant “targeted” advertisements. In other words, using modern computerized information systems, individual consumers are identified for their likes and dislikes and probable current and future purchases. By directing individual advertisement signals to individual known viewers, the ads they view are targeted to their known proclivity to buy or not buy a product or service.

This is clearly seen today as a consumer browses the internet. One viewing or search of a product or service at a major internet based company, such as Amazon, can provide current need or want for a product or services. Further by maintaining a database on each customer, online retailers assemble knowledge about the consumer's prior purchases. Combined with current product viewing and searches, this information provides information about individual consumers which is very accurately targeted for their potential for purchasing particular products and services in the near and distant future.

Data from a plurality of different sources who track and maintain product and service information about individual consumers, can be assembled to yield lists of individual consumers who have interest in products and services in the present, and in the future. These lists are a very accurate predictor of the purchasing potential for targeted individual consumers for specific products and services. The vendors that supply these targeted advertising lists and systems design their systems to reside relatively close to the consumer within the so called communication ‘eco-system’.

For example, a targeted advertising system for Amazon would be connected to the web server that serves the various web pages to the consumer who is identified by electronic identifiers on their computing or viewing devices such as a MAC ID. While the web page is being rendered to the identified user or consumers, the consumer's ID is cross referenced with a list including the individual consumer, and the relational data about the consumers present and future potential purchases is discerned. The communicated digital signal to render the webpage to the consumer which is then adjusted to include the appropriate targeted ads which are identified as associated with a product or service desired by that individual, and placed within the web page before it is displayed to the consumer. Such a system however, does not work well in real time, for direct marketers within a television eco-system due to the large numbers of different provider systems to the segmented national population of viewers who are consumers. This is because the network connections that are closest to the consumer in their respective cable or satellite TV system, are typically too far removed from the advertisers to effectively manage communication of targeted ads that are timely presented to individual identified buyers from a plurality of lists.

In addition, points of distribution closest to consumer activity, have individual consumers come and go constantly (sometimes referred to as “churn”). A subscriber, such as one on a well known cable television provider's system, can become a subscriber on a competing network the next day with virtually no advanced warning.

Therefore, a direct marketer wanting to communicate with such an identified and targeted consumer will be thwarted in his attempt to make such a connection if the targeted advertising is communicated within the first network when the targeted consumer has moved to another network. In fact, a better position for communication of such a targeted advertising system to reside is further up in the ladder from the individual segmented network systems to broadcasters who communicate with all of them concurrently, and thus much closer to the content owner.

Prior art in providing advertisement and promotion today does not provide a system and method of such that resides within the broadcaster's network as would be advantageous since the broadcaster can reach virtually any consumer through any of its points of re-distribution, as long as the target consumers are watching content provided by that broadcaster. Therefore, a direct marketer would be much better served connecting to the broadcaster rather than the operator.

Taking a closer look at a direct marketer, one can clearly see the following procedures which are routinely followed:

1. “Lists” of specifically identified viable candidate consumers for a product or service are ordered from a trusted 3^{rd} party who maintains the database on individual consumer's interests for products and services(or agencies that provide a similar middleman function).

2. Consumers on these lists are then targets of the direct marketer's advertising campaign (whether it be mail, television, telephone, email, or any other method of reaching consumers in an off-line fashion).

3. The direct marketer monitors the various relevant markets to determine if the campaign is showing signs of success.

4. The direct marketer orders the relevant measurement data that will indicate the ultimate results of the campaign (for better or worse).

Further, given that traditional television networks come from a one-way environment (over-the-air, satellite, and analog cable), the systems and methods of allowing lists, the targeting of specific consumers and the follow-up measurement processes are not available to direct marketers today. Furthermore, if such systems and methods were available to direct marketers today, they would most likely use them which should further indicate that such an approach is not obvious (as people would be doing it today for the obvious financial gain).

There are two significant problems that face direct marketing groups when they look to television as an alternative for their advertising dollars. One problem is television networks were originally designed as one-way systems, and still perform many of the one-way functions to this day (although many television networks in the larger markets are now two-way systems). Another problem is the entire television market is changing dramatically as the internet begins to stream higher bandwidth video streams. An explanation of the nature of direct marketing groups and the problems associated with common-day television networks is provided below.

Direct marketing groups require the ability to generate lists of customer prospects for their goods and services and then actively market (advertise) their products directly to the consumers found on these lists. The most common ways for this to be accomplished today is by mail or telephone, and sometimes by email. It's typically considered any direct process that is not linked to internet web sites and web searching. Using a mail scenario, a direct marketer would purchase a list of prospective customers and mail each customer a mail piece, such as a letter, postcard, or any other type of package that a consumer would typically find in his or her mailbox. Such a method is efficient in the fact that the mail service can be depended upon to deliver mail pieces to virtually anyone on earth (who might be found on such a list).

The problem with using mail as a transport mechanism however, is the cost. Today an average mail piece costs $0.45 (cents) with $1 being a better cost for the more attractive mail pieces. It's obvious that direct marketers would prefer to use television as a transport mechanism with delivery costs in the range of pennies. However, television does not support lists of consumers and it cannot be depended upon to deliver the message to the targeted consumer. If such a network and system existed, then direct marketer would gravitate to it as the savings would be compelling to their overall business models.

It is known that a two-way television network has decided advantages over one-way networks, clever system designs can make these disclosures operable as well. For example, the use of carousel systems within satellite networks can simulate two-way functionality although the system delivers in one direction only. Therefore, a “list” of consumers and their electronic location identified on the network, can be “pushed” down to a set-top-box of consumers with the following instruction: If you or in this case, your identified media device identifying you, are on this list, then splice and substitute an advertisement found on the local hard disc drive, rather than the “default” ad that is embedded in the broadcast stream. It's not so much the alternative content coming from an external storage mechanism (as this technology is decades old) as much as it is the logic to display alternative content for people who are on a “list” as ordered by a direct marketing group.

It is well known that vendors of targeted advertising systems for television in particular have focused their attention on the operator rather than the broadcaster. An example would be a vendor that focuses the development of their software system to be relevant the operator rather than being relevant the broadcaster. The operator, such as a major cable television operator in the United States, are simply a single point of distribution for a direct marketing organization, and such a single point of distribution is not satisfactory to deliver targeted ads to the millions of manufactured “lists” of targeted consumers they produce each year. A broadcaster that distributes content to multiple system operators (such as Comcast, Time Warner Cable, Apple iTunes, Verizon Fios and others), are in a better position to fulfill the needs of direct marketing organizations.

Further, market trends have shown that the largest of content owners are becoming smaller, and smaller content owners are becoming larger. This is due to a number of factors including the internet and the absence of an absolutely secure content security scheme. It's also the result of strong emerging global markets, disruptive technologies, and new markets for long-tail content. All of these issues result in enormous stress on the largest of content owners (including major U.S. broadcasters). The response by the largest of content owners will be to downsize and refocus their energies on the most productive aspects of their business.

Although this is a short-term solution for these content owners, it will assure large and steady streams of revenue within the foreseeable future. They may be able to involve themselves in new and disruptive business models as well; however, such efforts typically do not return profits in the shorter term. In fact, some disruptive models may tend to undermine existing profitable business activities for these same content owners. So what should their response be to the problems they are now facing? The largest of content owners may find the best response to the various threats that now face their long-time business models is to develop a better relationship with consumers (and not simply their distribution partners), and to personalize the media experience.

Other problems that victimize content owners are the disruptions caused by interactivity. For example, if a consumer wants to learn more about a pair of sunglasses worn by James Bond, it's possible to navigate to a site that is populated with information about said sunglasses; however, a consumer may then get lost in the story line. Losing a consumer in the story could then create the worst of all scenarios for the content owner; the consumer may switch to another content title or switch modes of entertainment entirely, thereby losing the attention of the consumer.

As such, there is a continuing unmet need for a system and method of advertising that allows direct marketing groups to use television by way of their existing routines and practices rather than the focusing on well known systems and functions such as those mentioned previously.

The invention should advantageously provide information and interactive services during a segment of the content where consumers expect to see advertisements. For example, if television episodes could maintain their logical commercial breaks (designed to keep the consumer in suspense) and then deliver personalized information and services to a consumer (both relevant and compelling), then the major content owners can enjoy the following results:

End-consumer loyalty (as the experience is enjoyable and compelling)

Personalization

Added revenue from new advertising budgets (previously not dedicated to television).

### SUMMARY OF THE INVENTION

The device herein disclosed and described provides a solution to the shortcomings in prior art in advertising communication and achieves the above noted goals through the provision of a marketing and advertising system to coordinate activities between the direct marketing organizations, organizations that generate relational databases and then provide “lists” of viable consumers, broadcasters, operators (i.e. cable television companies and other such distributors), broadcaster affiliates, post-distribution measurement companies, and other important points of distribution and data gathering functions.

For the purposes of this disclosure, the following definitions will apply:

‘Broadcaster’ will refer to major content owners that broadcast or otherwise distribute their television content to other points of re-distribution. Examples of well known broadcasters in the United States at the time of this writing are: FOX, CBS, NBC, ABC and other smaller broadcasters such as ESPN, MTV and SHOWTIME.

‘Trusted 3^{rd} party’ or list provider, will refer to provider of lists of consumers who have been identified as candidates for products and/or services based on their credit history and/or buying patterns. One well trusted 3^{rd} party known around the world is EXPERIAN.

‘Direct Marketer’ (also abbreviated as DM) will refer to an organization that routinely orders lists of viable consumers from TRUSTED 3RD PARTIES or list providers, and then sends information and incentives to the consumers found on these lists, and ultimately receives measurement data indicating the success (or failure) of the various advertising campaigns.

‘Affiliate’ will refer to local broadcasters that are aligned with the larger broadcasters that have agreements in place to further supplement programming and share ad spots during media broadcasts known as “avails”. An example of such an affiliate would be San Diego Calif.'s KFMB Channel 8—a CBS affiliate.

‘Measurement Company’ will refer to any company that uses empirical data from numerous sources to measure the success or failure of a given advertising campaign. There are many such measurement companies that are known in the industry; however, it is important to note that such a measurement function can alternatively be performed by the trusted 3^{rd} party.

Briefly, the system begins when a company engaged in providing a valuable product or services (referred to as a “Brand”) either orders a list of target consumers associated with particular products or services directly, or hires an agency to order such a list on their behalf. It is well known that the higher-quality (and more expensive) lists typically yield better results (i.e. more efficiency in closing transactions for the “Brand”). Such a “Brand” can create numerous lists and have rules and policies that apply to the various lists.

Factors to be addressed upon further disclosure of the detailed description include, what happens when the same consumer is on two lists, if a consumer is found on a list and the consumer shows up numerous times, and will this consumer see the same ad each time, or will the consumer see a different ad each time he or she views content.

It is important to note that multiple lists can be provided to “Brands” and multiple “Brands” may be involved in this mode of television delivery. Therefore, large databases must be configured that are designed to store huge amounts of “list” data that can then be transferred to the various down-stream distribution partners for the content owner.

It is further important to note that down-stream distribution partners can be among the following: Cable Television, Satellite Television, IPTV, Over-The-Top, Netflix, Hulu, Mobile Services, International Carries, and many others. Therefore, the disclosure in this patent application provides that such “Lists” be distributed to all operators who further distribute the content owner's video communication or products. Such an undertaking these days is easier in some ways, and in some ways it's more difficult as described in aspects of the preferred modes immediately below.

As the world becomes more “connected” each passing year, a content owner's ability to have a direct connection to the distribution supply chain and the end consumer increases dramatically. The ease of making such a connection is also simple (given the myriad of routers and switches that can be easily programmed).

The difficulty comes when an advertisement content owner must now connect itself to hundreds if not thousands of distribution partners. In addition, content owners may soon want to make connections directly to consumers (which could number in the hundreds of millions if not more). Adding one more dimensions, these consumers may have a plethora of devices (PCs, TVs, Mobile Phones, Pads, and others). Therefore, a viable network architecture would need to create and store lists of consumers, make these lists available (yet secure) on electronic memory storage systems throughout the distribution supply chain, and then see it that consumers who are identified on these lists are provided with the ads for products associated with each individual consumer that is properly associated with the product on the the lists.

Network security is a preferably highly considered aspect of the present invention. It is important that such a network as described in this disclosure would need to have state-of-the-art network and client-side security. All appropriate cryptographic functions and systems can be properly placed throughout the network to ensure that only authorized access can take place.

All data associated with consumers must be kept confidential and secure. The method of maintaining a proper level of security to protect the consumers on such a network (as described in this disclosure) revolves around a trusted 3^{rd} party that is tasked with holding the public and or private keys that are used to decrypt consumer level data, perform the necessary “matching” functions to ensure ads are associated with and then sent to the proper associated consumers for the product or service. Further, reports of the delivery of such ads (and other interactive systems and functions), must be assembled and then ensure the keys are properly regenerated or destroyed.

In short, all consumer level data will be kept in a highly encrypted state with the electronic decryption keys being managed by the trusted 3^{rd} party. Only the trusted 3^{rd} party can use the keys to decrypt the consumer-level data, perform the necessary functions that are necessary as described in this patent application, and then regenerate or destroy the keys at given intervals to ensure than any system hacks do not have enough time to wreak any significant havoc.

It is additionally preferred that memory storage devices and systems storing and communicating the lists, employ encryption systems which allow for the use of multiple decryption keys. This way the owners of the data can see their own encrypted data, however, will not be able to see encrypted data that belongs to another party. Therefore a large list can contain consumers associated with multiple products from multiple vendors but is encrypted to allow only individual parties to only view data authorized them. When an entity such as a trusted 3^{rd} party has multiple keys (as provided by the various partners), only they can unlock all of the data in order to perform important functions such as marrying list data to the intended consumers.

In another preferred mode however, a direct marketing facilitator can perform the functions of a trusted 3^{rd} party. This means the direct marketing facilitator will have all of the systems, functions and even physical security means to handle encryption keys and the passing of secure data securely.

Further, each list that is created will be immediately encrypted and passed to the direct marketing facilitator. The decryption keys will be securely passed to the direct marketing facilitator as well. In order for list data to be accessed, either the DM facilitator must query the various lists it has in its databases using the appropriate decryption keys.

Likewise, any consumer-level data must be encrypted before it leaves the distributor's databases. If such encrypted data leaves the domain of the distributor, it must be sent to either the DM Facilitator (acting as a trusted 3^{rd} party) or a separate trusted 3^{rd} party.

Revenue splits for performing the functions of matching list data to consumers on a network must be formalized in order for this model to work. (The key individuals and companies within the distribution supply chain will not cooperate unless they are properly compensated.) It is particularly preferred that the different revenue splits as are negotiated independently and the changes to the revenue splits that will occur on a routine basis (as agreed by way of negotiation). Such a system will require an entity to maintain the revenue split information and see to it that revenues are apportioned and payed-out as agreed by each stake holder. Although the trusted 3^{rd} party can perform this function of properly splitting revenues among the stakeholders, the preferred mode for this disclosure is the DM Facilitator perform this function.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of the invention to provide a system and method for allowing functions that have been previously established for direct marketers to send mail packages to consumers (and perform telemarketing campaigns), to instead use digital television networks.

### BRIEF DESCRIPTION OF DRAWING FIGURES

The details of the present invention, both as to its structure and operation, may be gleaned in part by study of the accompanying drawings, in which like reference numerals refer to like parts.

FIG. 1 is a block diagram illustrating a traditional television distribution network.

FIG. 2 is a block diagram illustrating more of a current-day television distribution network including on-line and mobile means.

FIG. 3 is a block diagram illustrating the location of targeted ad systems for direct marketing indicating the fundamental problem for direct marketers.

FIG. 4 is a block diagram illustrating the connection of targeted ad systems for direct marketers.

FIG. 5 is a block diagram illustrating the hierarchy for direct marketer involvement and the introduction of the “lists” of consumers necessary for direct marketing campaigns.

FIG. 6 is a block diagram illustrating a description of the lists and the basic flow of the lists.

FIG. 7 is a block diagram introducing the direct marketing (DM) facilitator of the present invention.

FIG. 8 is a block diagram showing the relative position of the DM facilitator within the system.

FIG. 9 is a block diagram illustrating the distribution of data from the DM facilitator to the distributor headends.

FIG. 10 is a block diagram showing a plurality of video-enabled consumer devices that receive video streams from a distributor by way of a headed.

FIG. 11 is a block diagram showing the DM facilitator managing the lists and measurement data in addition to other mission critical functions and processes.

FIG. 12 is a block diagram of a new hierarchy with a DM facilitator.

FIG. 13 is a screen showing an example of a user interface.

FIG. 14 is a block diagram showing a network that has numerous systems and processes hosted in cloud-style networks.

FIG. 15 shows a master command and control center that would be necessary to manage all of the lists and distribution systems throughout the network.

FIG. 16 shows an example of linear ad insertion and national ad insertion.

FIG. 17 shows an example of linear ad insertion and local ad slots.

FIG. 18 provides an example of processing for delivering directed marketing DM advertising to an individual.

FIG. 19 shows additional processing steps for that of FIG. 18.

FIG. 20 shows an additional processing step of FIG. 18 applying subscriber credits for watching ads.

FIG. 21 shows an example of mapping a Direct Marketing (DM) target or individual to one or more subscriber devices on one or more networks.

FIG. 22 shows additional processing steps.

FIG. 23 shows an additional processing step of FIG. 18 including list grooming such as the elimination of duplicate entries, removal of targets with unknown addresses or who cannot be reached.

FIG. 24 shows still an additional processing step of FIG. 18 including user response.

### DETAILED DESCRIPTION OF THE PREFERRED EMBODIMENTS OF THE INVENTION

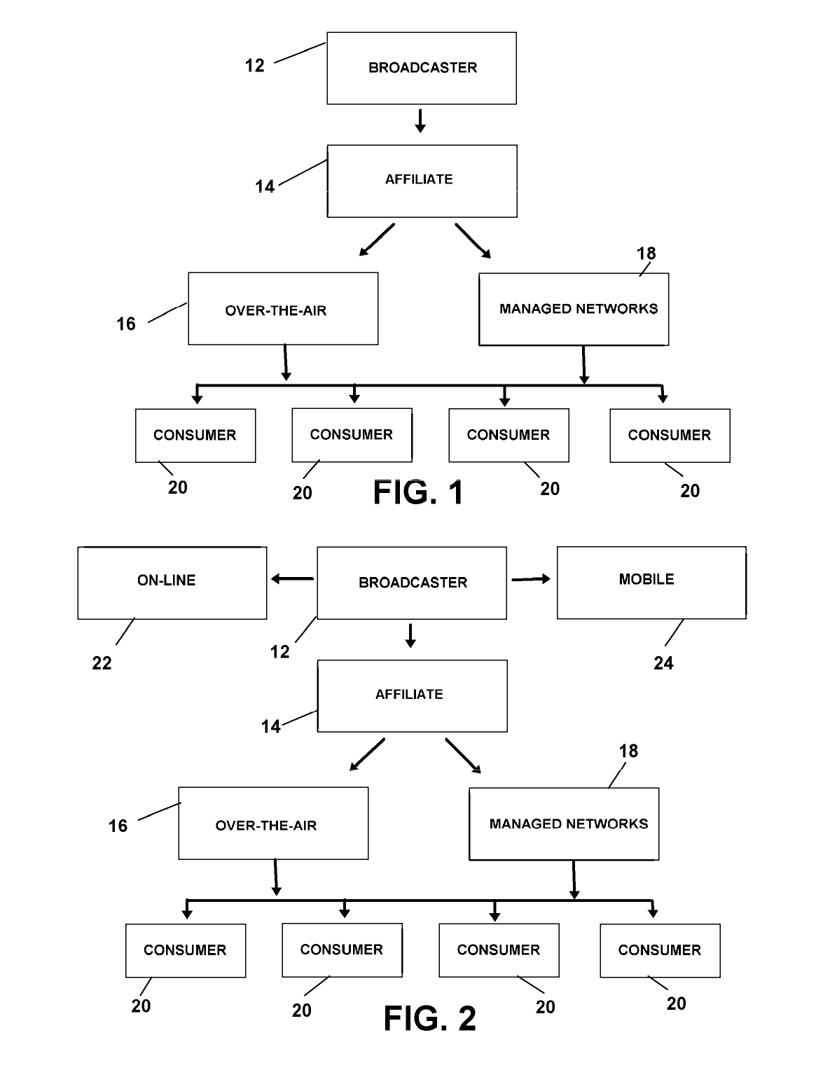

Now referring to drawings in FIGS. 1-24, wherein similar steps and system components are identified by like reference numerals, certain preferred modes as disclosed herein provide for network distribution of digital media advertising.

It will become apparent to one skilled in the art how to implement the invention in various alternative modes and alternative applications employing the networked system herein. However, although various modes of the present invention are described herein, it is understood that these embodiments are presented by way of example only, and not limitation. As such, FIG. 1 a schematic block diagram illustrating the prior art system of distributing television or other forms of entertainment content from a television studio, movie studio, content creator, or broadcaster 12 to distribution partners or affiliates 14 and then to platforms such as over-the-air service providers 16 or subscriber system operators such as satellite television and cable networks 18 and then ultimately to the viewer or consumers 20. This is considered a traditional model of television distribution and is, for the most part, a one-way distribution system with little or no information coming back through the system from consumers 20 or this distribution supply chain and ultimately back to the broadcasters 12. In addition, very little intelligence about individual consumers 20 is used for this type of distribution network.

FIG. 2 is a block diagram of the same fundamental system as described in FIG. 1 with the difference being the addition of On-Line Media Distribution Points 22 and Mobile Media Distribution Points 24 as well. These new points are important to note as the television networks that were known since the 1960's will soon be under stress to change dramatically as consumers will look for more media services on-line and from local wireless carriers.

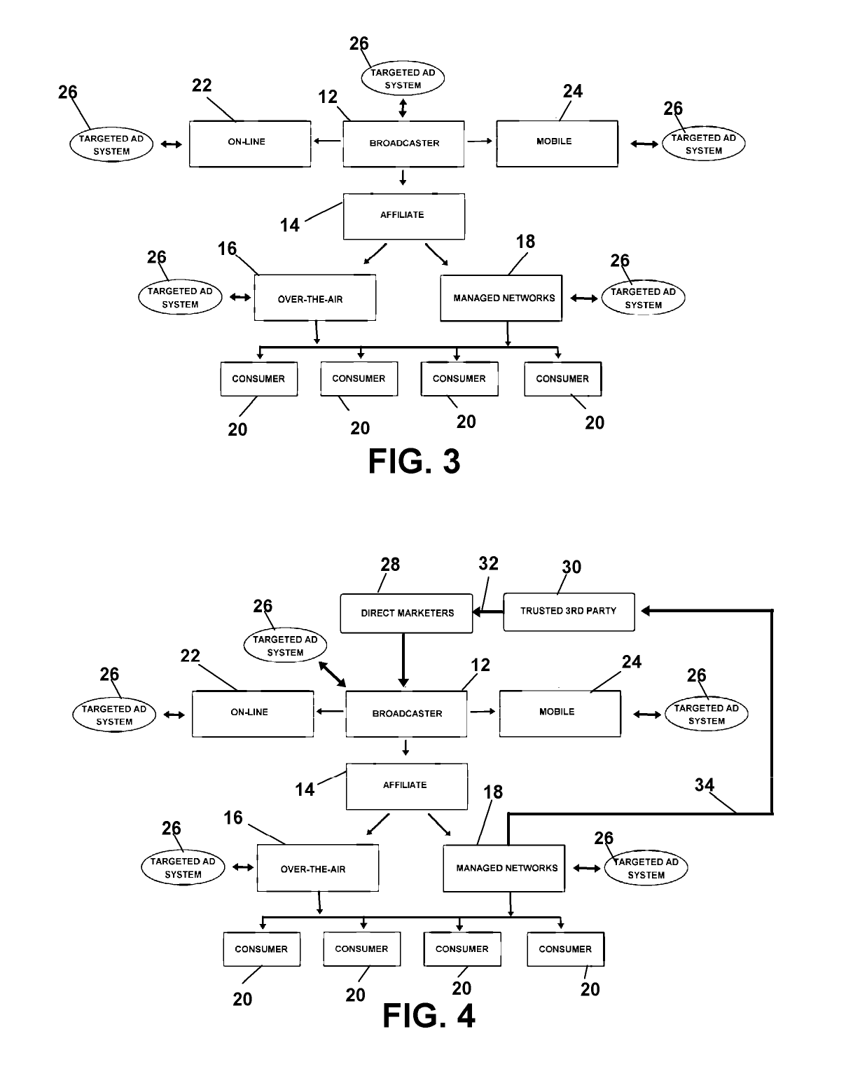

FIG. 3 is a block diagram that begins to describe the basic building blocks for a two-way networked system that will allow direct marketing groups to use a television network to effectively advertise their products and services. Targeted advertising systems 26 are placed at all distribution points throughout the network. These targeted ad systems 26 have electronic connection to the electronic conduit supplying subscribers 20 and provide the required electronic storage and computers running software adapted to the task of performing all necessary two-way functions to receive, store and pass forward digital content, meta-data, employ relational databases and store electronic data and employ the onboard software to accomplish the purposes of this disclosure.

FIG. 4 is a block diagram introducing direct marketing groups 28 and credit reporting agencies 30, or other trusted 3^{rd} parties. For direct marketing groups 28 to use established television communication systems, for the targeted electronic delivery of information and incentives to their targeted customers 20 who are subscribers to the system provider. From these locations the direct marketing groups 28 would need to interface into the electronic conduit or communication network providing connections to the subscribers or customers 20 from the system provider.

Additionally, from these vantage points, or other secure data collection and relating relational databases can be comprised and stored as the target “lists” 32 of consumers 20 or subscribers, which once generated can be distributed throughout the communication system of the system operators providing individual connections to subscribing consumers 20 who receive their TV and streaming media through the system operator from the broadcasters. In addition, response data input by subscribing consumers 20 and other results 34 from a given ad campaign can be measured and sent back to both the third party such as the credit reporting agency 30 and the direct marketing personnel 28.

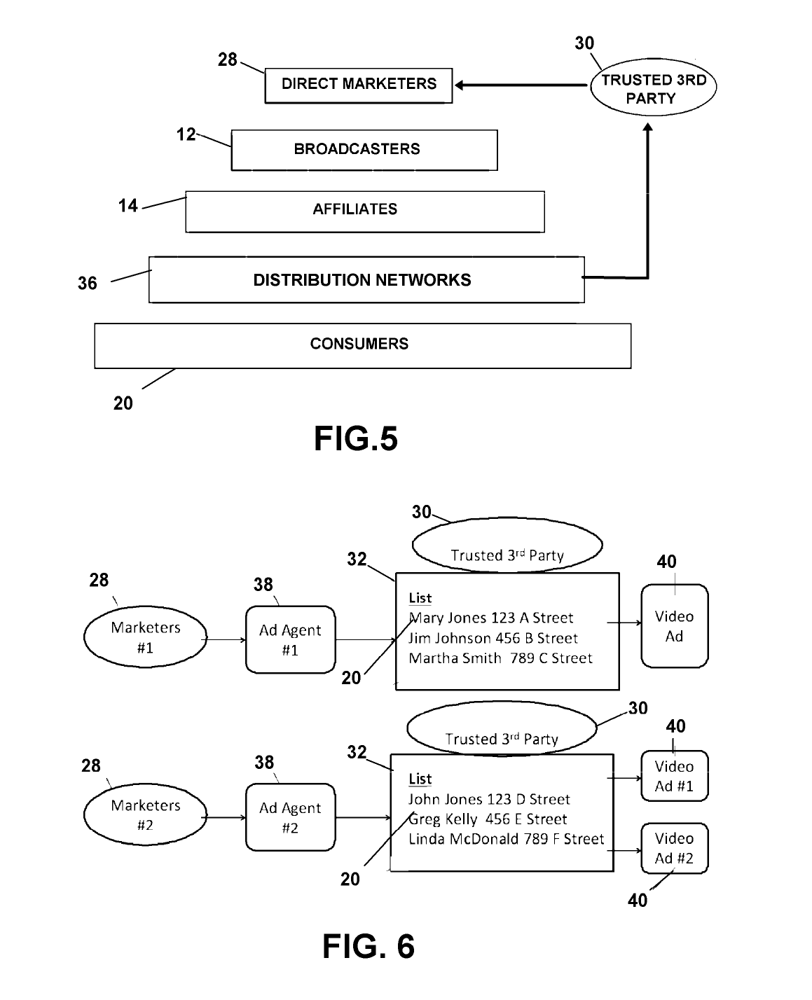

FIG. 5 describes a hierarchy of the various points of distribution with direct marketing groups 28 on top and with the trusted third party such as credit reporting agencies 30 connected to the direct marketing groups 28 and also connected to the distribution networks 36. Such a hierarchy is important as new broadcasters are starting to appear all over the globe and new consumer opportunities are rampant by way of new and faster network infrastructures. In the future, direct marketers 28 will need to find consumers 20 using a relational database which associates them with electronic identifiers of one or a plurality of electronic media devices, no matter where they are in the world. Such a hierarchy as provided in FIG. 5 will be needed to support such search and targeting efforts.

FIG. 6 is a block diagram that describes the List 32. Direct marketers 28 often by way of ad agencies 38 collaborate to create lists of consumers who are candidates to receive targeted information about a certain product and service offered by the direct marketer 28. These direct marketers 28 and the ad agencies 38 often go to credit reporting agencies 30 to purchase lists 32. These lists 32 are then used to target consumers 20 based on relational information as to income, status, location, known owned products, and other data associated with each consumer 20 in a relational database, which credit agencies 30 are know to generate. The targeted ad or information relating to some known proclivity of the consumer 20 to purchase a product or service, are communicated directly to the identified subscribing consumer 20 in real time, as they are watching television or other media content using a media reproduction device which produces video and audio locally using the electronic communication received from their connection to system provider. FIG. 6 also shows how the consumers 20 on the lists 32 can be targeted with one video ad 40 or with multiple video ads 40 depending on the number of what they may be related with on the relational database used to identify them.

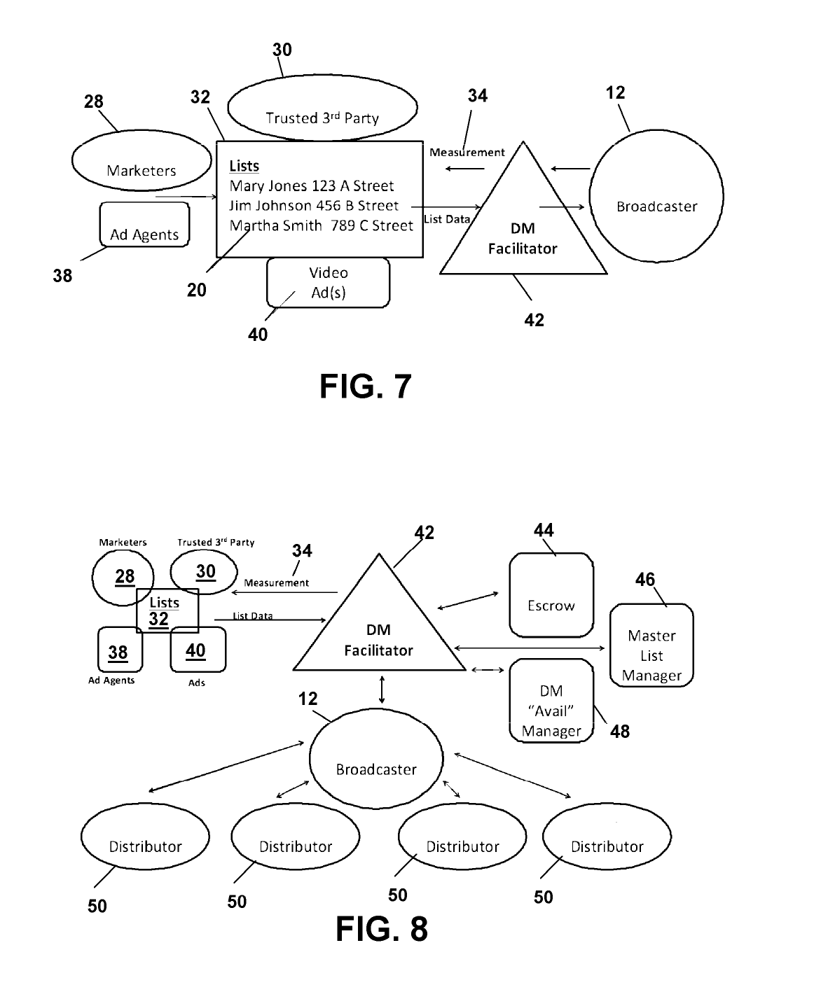

FIG. 7 is a block diagram of a new and novel entity (as described in this disclosure) named a “Direct Marketing Facilitator” or “DM Facilitator” 42. The DM Facilitator 42 is required to connect the various stake holders within the distribution supply chain in addition to customizing the experience and requirements for each stakeholder.

The primary responsibility for the DM Facilitator 42 is managing the lists 32, associating the correct media or videos 40 concerning products or services with consumers 20 identified as a target for the product and services in the lists 32. Then they bundle them for the broadcasters 12 in such a way as they can distribute the necessary information through the electronic network to the underlying system providers who provide the connections to the consumers 20. The facilitator 42 also sees to it that the requirements of the marketers 28 and carried-out and that the data collection and measurement data 34 is properly received, electronically stored, and packaged for communication back to the marketers 28 and the ad agencies 38.

FIG. 8 is a block diagram showing more of the eco-system of a network that would allow direct marketing functions and processes and the relative position of the DM facilitator 42 within the eco-system. As can be seen in the figure, the DM facilitator 42 will be provided communication with an third party or escrow agency 44, a master list manager 46, and an time slot or avail manager 48. Broadcasters 12 then distribute the necessary information to a plurality of distributors 50.

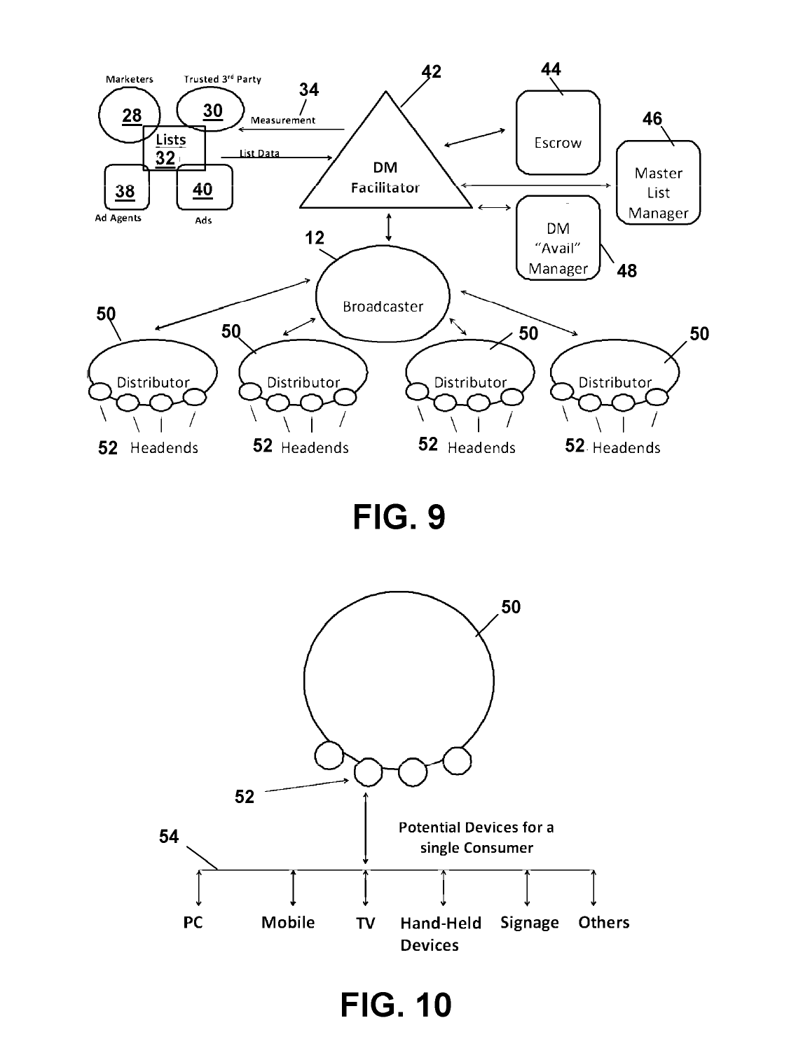

FIG. 9 is a block diagram that describes the same eco-system with the introduction of headends 52. These headends 52 are the last nodes in the chain that ultimately connect to the consumer. The targeted ad systems 26 with requisite electronic memory, computer, and software, described in FIGS. 3 and 4 can be placed in these headends 52.

FIG. 10 is a block diagram showing a multitude of video-enabled consumer devices 54 that receive video or media streams from a distributor 50 by way of a headend 52.

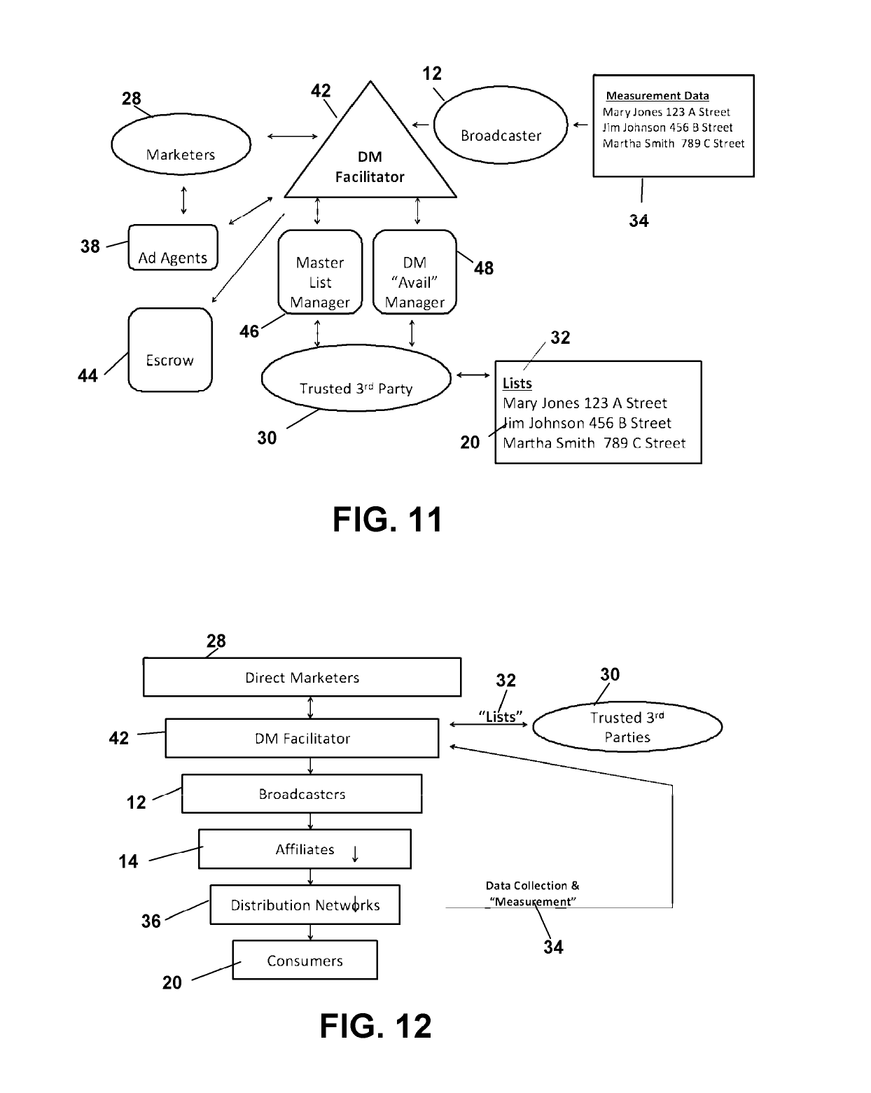

FIG. 11 is a block diagram showing the DM facilitator 42 managing the Lists 32 and measurement data 34 in addition to other mission critical functions and processes.

FIG. 12 is a block diagram of a new hierarchy with a DM facilitator 42, and the relative position of the DM facilitator 42 within the larger eco-system. The DM facilitator 42 will perform the steps necessary to manage the lists 32 and the measurement data 34.

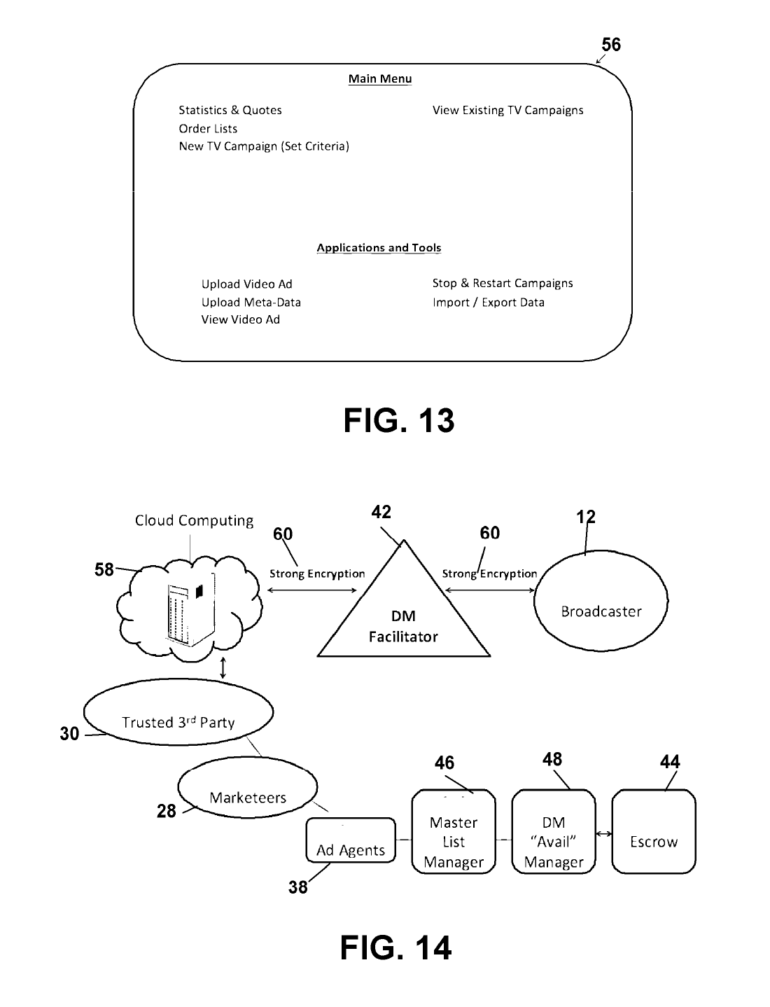

FIG. 13 is a screen showing an example of a user interface 56. Such a user interface can be used by an advertising agency 38, an advertiser, and even a private individual looking to post an ad on a television network based on a consumers or subscribers to the network being on the list 32. Such a User Interface 56 could have numerous applications, tools, links, sub-systems, and processes as well, and as such should not be considered limited to the depiction in the figure.

FIG. 14 is a block diagram showing a network that has numerous systems and processes hosted in cloud-style 58 networks, however, the connection to the broadcaster 12 contains either strong encryption 60 or a private network to avoid potential any threats from hackers.

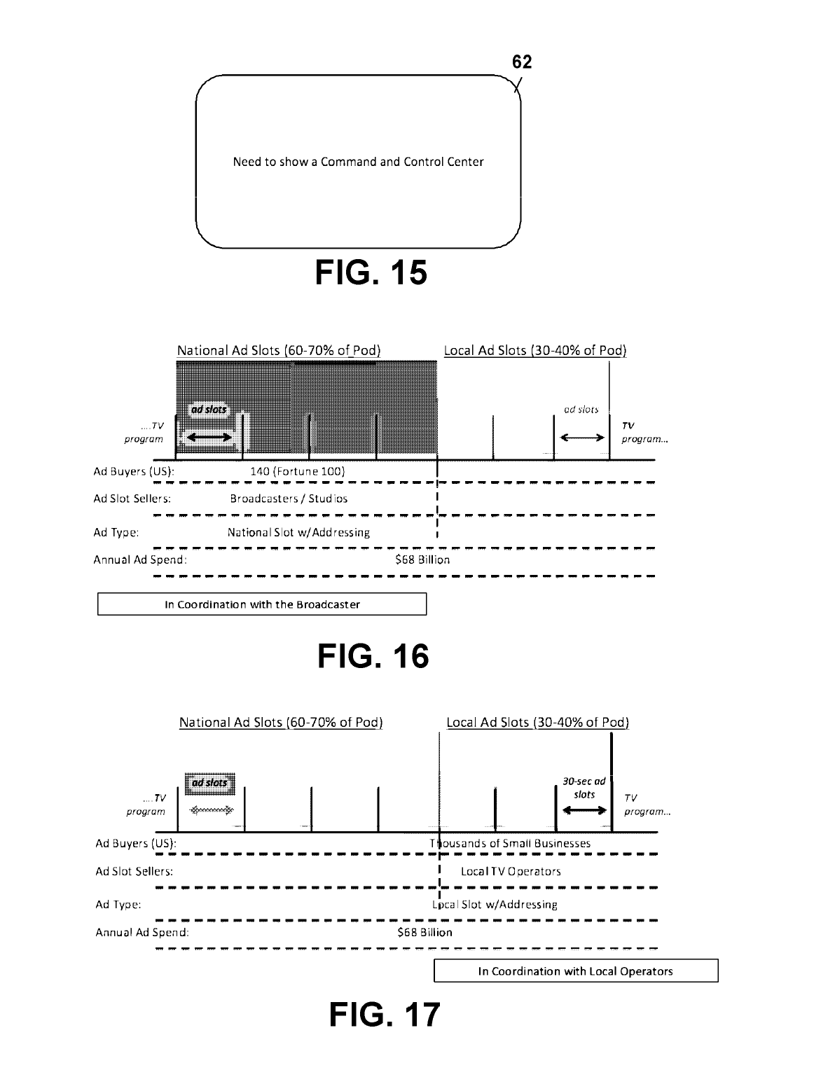

FIG. 15 shows a master command and control center 62 that would be necessary to manage all of the lists 32 and distribution systems 36 throughout the network.

FIG. 16 shows an example of linear ad insertion and national ad insertion.

FIG. 17 shows an example of linear ad insertion and local ad slots.

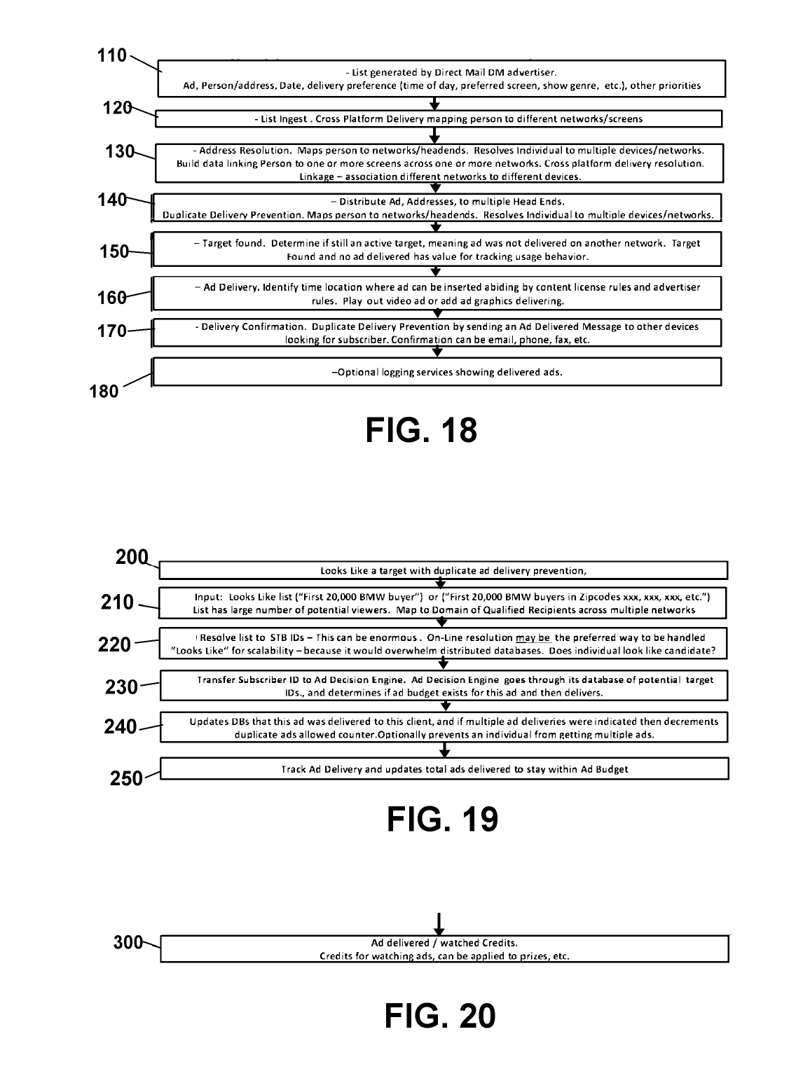

FIG. 18 provides an example of processing for delivering direct market advertising to an individual such as the subscribing consumer 20 to the communication system of a system provider. Direct marketing delivers advertisements to targeted specific consumers or subscribers, identified by the one or a combination of their name, address, and associated electronic identifier or the electronic devices employed by that individual for reception of media. Direct marketer is analogous to Direct Mail advertising using postal mail services.

In FIG. 18 processing step 110 generates a list 32 in any format of an advertiser (Direct Mail DM advertiser) containing one or more data elements of a list 32 such as individual name, individual address, or the electronic identifier of a device employed by the consumer 20 to view media such as a TV, computer, laptop, smartphone, or phone number associated with the advertising target or other data that indicates a match in the relational database of a proclivity to buy a product or service by the targeted (or desired) individual for that which is included in the advertisement.

List output in step 110 contains identifiers of one or more individuals to whom the advertiser is targeting the ad. List 32 can optionally contain other information such as a person or current resident at an address, a delivery date, delivery preference (time of day, preferred screen, show genre, etc.), electronic identifiers of the individual connected to the system provider, and other data. Any of the data described herein can be sent to the client device, such as a satellite receiver, cable box, video game engaged to the network, smartphone, computer, either in-band (in the video content being viewed) or out-of-band (external to the content being viewed) or a combination of the two.

Processing step 120 the electronic device engaged with the system provider's system, reads the list 32 (List Ingest) and prepares the data if necessary for cross platform delivery to different devices at the consumer's 20 location, including mapping a person or target to different networks and different devices/screens on the different network. In one example, Step 120 creates a list of networks where an individual was last known to reside such as Set Top Box IDs 1,3,9 on network A, mobile phone 7,19, 45 on mobile network B, PC IDs 44, 904 on mobile network B, PC ID 44, 918 on network A and C, etc. In addition optionally formats the actual ad being delivered for the different networks such as high-definition for Set Top Boxes and PCs, mobile for mobile phones, etc.

Step 130 optionally provides additional address resolution mapping a person to networks/headend address or client ID in case processing in step 120 did not resolve the address mapping to a specific client ID on a network. In many cases a targeted individual will have multiple devices having respective individual electronic identifiers such as a MAC ID, or IP address or combinations thereof, and the association of an individual to multiple devices across multiple networks is resolved in this step.

Build data links a consumer 20 to one or more electronic devices with identifiers and having screens across one or more networks. In this application the term person or consumer 20 applies to any individual or group of people that an advertiser desires to send an advertisement. The term “target” applies to one or more individuals that an advertiser desires to send an advertisement based on the individual person, a list of individuals, or other advertiser desired characteristics such as “looks like a BMW car buyer”, or “looks like a person who travels”, etc. The terms person, persons, target, and targets are used interchangeably to indicate one or more individuals, devices, or groups of devices that an advertiser desires to send one or more advertisements.

The data and processing step 130 describe an optional Linkage step that identifies an individual or a target across different networks with one or more different devices. In the event the different devices require different data such as video format, or ad delivery protocol, etc. appropriate processing is envisioned to properly identify the individuals, devices, and properly deliver and track ads across the different networks, along with data conversion for proper processing.

Once a target or person is input to the system described herein, processing step 140 determines the one or more networks that can be used to distribute the ad to a person. When a target is accessible on multiple networks such as cable, IPTV, mobile, PC, game console, etc. processing herein delivers ad target and ad data in the correct format for multiple device deliver to a plurality of network distribution points such as one or more cable headends, mobile broadcast centers, Internet distribution headends, etc.

In many ad campaigns an advertiser would like to limit the number of duplicate ads delivered to an individual. For example, a advertiser may decide that any target gets only one ad regardless of how many different networks or different devices they may own. Individually and collectively the advertiser related controls on duplicate ad delivery will be referred to as advertiser delivery rules. Any form of advertiser delivery rule processing is envisioned in this patent application. Processing step 140 includes logic to prevent or resolve the number of times an ad is delivered to the same individual.

This processing prevents duplicate ad delivery or limits the number of times an ad is delivered to an individual across multiple disparate networks. For example, this processing allows advertisers to indicate that John Smith should receive only one copy of this ad, or three copies on a PC or STB. As such, processing step 140 associates a target or person to multiple networks/headends and determines before an ad is delivered if the target should receive the ad.

Unlike traditional broadcast advertising and even current day targeted advertising system, one element of this invention is to seek out and find an individual or a target. Processing step 150 identifies that a person or target was found. Processing then determines if this person is still an active target, meaning an ad was not delivered on another network. In the event the target received an ad from another network then the ad is not delivered. This processing can occur either by checking a targeted ad delivered database, or by the system components sending messages to other system components at different networks/headends that an ad was delivered.

In one example the fact that a Target Was Found and no ad delivered has value for tracking usage behavior of subscribers. Of course, a target found and ad delivered has significant value in usage tracking and the system supports both methods of tracking as well as any other method of tracking such as tracking the viewing habits of a subscriber even without the subscriber being on a Target List (list of subscribers an advertiser desires to reach).

In step 160 an ad is delivered and the delivery is tracked by the system. Ad delivery logic identifies time locations in content (movie, broadcast TV, etc.) where a DM ad can replace an existing ad, or be added based on the terms of the content license for the content being viewed. Ad delivery logic optionally creates DM ad slots during TV or viewing events such as switching channels, viewing TV menus such as the Electronic Program Guide (EPG), or a Video On Demand (VOD) purchase menu. Ad delivery processing updates the Ad Budget tracking to make sure only the number of pre-authorized ads are delivered during an ad campaign. For example, an advertiser may authorize payment for the first 200 individuals available from a list of 1,000 targets. In one example, a DM targeted individual has been identified and the device they are viewing is active an ad is delivered. In another example, the current occupant of a house or apartment receives an DM ad by virtue of the physical address of their current location similar to postal mail delivery to “John Smith or Current Resident of ” a particular postal address.

In another example, a DM ad is delivered to a person based on an identified characteristic of the individual.

Step 160 includes partial ad delivery logic in the event that the viewer does not watch enough of the ad being delivered. Partial Ad delivery logic will indicate that the subscriber did not watch enough of the ad and will not indicate that the ad was delivered, rather it can track a partial delivery, or simply not update the ad deliver counter/logic for this target. Partial ad delivery processing can use any type of logic or tracking during its processing, such as counting the number of partial attempts, tallying the number of seconds actually watched, updating the ad delivery counter after N number of attempts and N-seconds of the ad delivered in the N-number of attempts, etc.

Step 170 reports Delivery confirmation for billing purposes and to prevent duplicate ad delivery. In one example, all the networks/headends/paths where a subscriber is known to be are updated with delivery confirmation, in another example a central site tracks delivery and removes the target from it target list (persons/devices being targeted). Confirmation can be updated/reported in any format including computer data message, a database update, an email, phone, fax, etc. An optional step provided certified ad delivery similar to a certified postal mail delivery, and certified ad delivery may also include the subscriber providing feedback on the ad being viewed.

Optional step 180 logs delivered ads in a log format for billing purposes.

Processing steps in FIG. 19 allow targets to be identified not by an individual name such as John Smith but the individual characteristics such as the individual not known by name but by a desirable characteristic such as the individual looking like a BMW buyer, or a luxury vacation traveler. “Looks Like” targeting data can be common across one or more networks, or network specific or any combination thereof.

In step 200 certain viewer characteristics are determined by the advertiser such as targeting individuals who look like BMW buyers. Identified individuals or desired individual characteristic data from any data source such as monitoring what TV channels the individual watches, or time of day they watch tv, or geographic location, or data input from credit reporting data sources, or the operators customer relations management (CRM) data base, or “looks like” data identifying individuals who are desired targets, or other data sources.

To avoid being overly redundant in this figure and other figures in this patent application the description of each figure, other processing steps described in later FIGS. 20-24 in this application can be combined to further define and refine the ad delivery, tracking, ad budget tracking, duplicate ad delivery, cross-platform ad delivery, confirming delivery, etc. For example, in FIG. 19 “looks like” target data can be combined or uses other system other processing steps described in later Figures for ad delivery, tracking, ad budget tracking, duplicate ad delivery, cross-platform ad delivery, confirming delivery, etc.

“Looks Like” a target includes duplicate ad delivery prevention across multiple networks with or without unifying user traits known only to a specific network to prevent duplicate delivery to the same individual over different networks/devices. In one example, information about a mobile user may be a subset of the information known on the cable network used by the same individual and “looks like” targeting can use network specific subscriber characteristics when identifying an individual or common characteristics across all networks.

In step 210 data is input identifying the Looks Like list (“First 20,000 BMW buyer”) or (“First 20,000 BMW buyers in zip codes xxx, xxx, xxx, etc.”). The list may have a large number of potential viewers with only a small subset actually receiving ads. Various processing techniques such as distributed computing or real-time target validation, or other optimization steps can be used to prevent the data storage and processing requirements at each ad decision point from becoming enormous.

The “looks like” target list is mapped to qualified recipients who may have devices on multiple networks. In summary “looks like” uses advertiser desirable identifying data such as household income and matches this advertiser desirable attribute to individual profile data. And, when the individual data meets or exceeds advertiser desirable data the matching individual is considered an appropriate target and this individual is included into the acceptable target pool of individuals who meet advertiser qualifications.

Step 220 resolves the “looks like” list to client device IDS such as PC IDS or mobile phone IDs or STB IDs.

Step 230 transfer subscriber ID to Ad Delivery processing for that network. Processing steps in FIG. 18 perform ad delivery validating sufficient budget for ad delivery and performing duplicate ad delivery processing. While shown discretely in FIG. 19 but can be based on details shown in FIG. 18, step 240 updates data that this ad was delivered to this client, and if multiple ad deliveries were indicated then decrements duplicate ads allowed counter prevents an individual from getting multiple ads.

Step 250 Track Ad Delivery and updates total ads delivered to stay within Ad Budget

FIG. 20 extends the processing of FIG. 18 applying subscriber credits for watching ads 300. Subscriber credits can be used for any incentive reward purpose such as applying credits for free TV viewing, or for winning prizes or any other promotion.

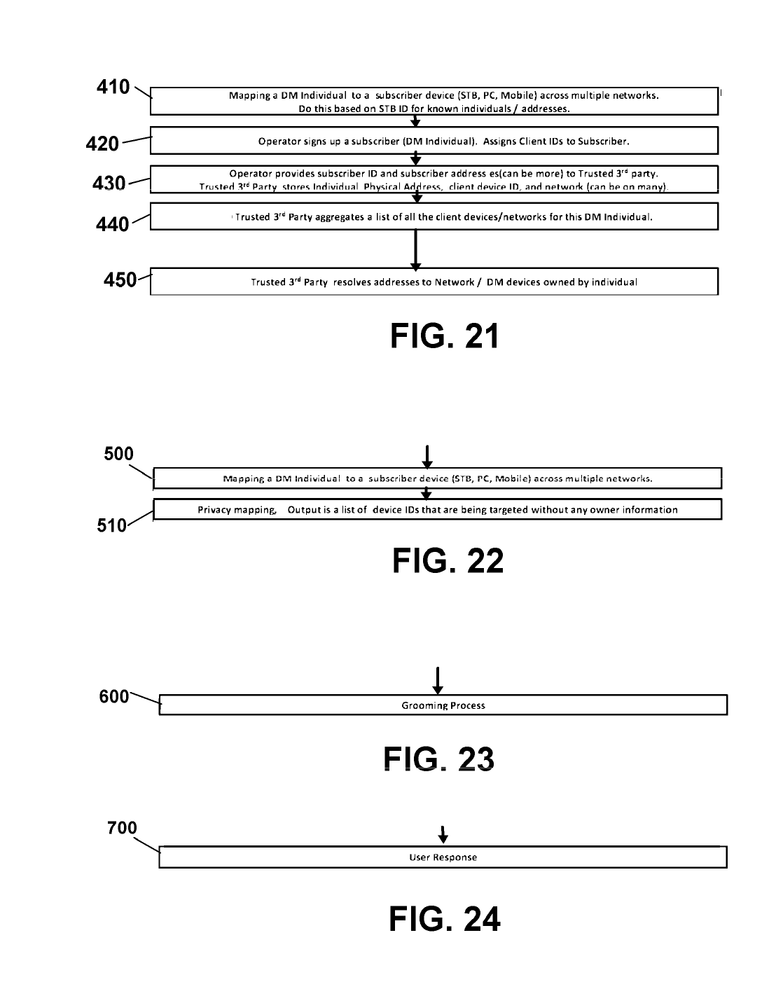

FIG. 21 shown exemplary language for mapping a Direct Marketing (DM) target or individual to one or more subscriber devices on one or more networks. This high level function is shown as Step 410 Mapping a DM Individual to a subscriber device (STB, PC, Mobile) across multiple networks. This processing can be performed by any one or more companies (entities) in the ad distribution chain, and can be performed by a trusted 3^{rd} party that manages the service or protects the identity of individuals.

In FIG. 21, a video operator (cable operator, mobile operator, Internet video operator) who provides video delivery services to a viewer or subscriber performs an association of an individual subscriber (e.g. John Smith, or a physical address of a subscriber, or both) to one or more devices registered for service with the video operator. In Step 420 when the video operator signs up a new subscriber they will have a name and possibly an address for the subscriber. The operator will associate one or more subscriber devices (phone, STB, PC, etc.) having device IDs to the subscriber. This data is used to identify what client devices can be used to reach a particular targeted individual (e.g. John Smith). For example this data indicates that John Smith can be reached at device ID xxx on cable network 5.

There are many different ways this subscriber/device association can be performed. In one example, the subscriber/device association is performed by a trusted 3^{rd} party that protects the identity of the actual individual only providing data identifiers without revealing the identity of the individual. When a trusted 3^{rd} party is used, individual name information of targeted information is input to the trusted 3^{rd} party and the trusted 3^{rd} party outputs only device/network IDs.

Trusted 3^{rd} Party can further protect the individual name, or physical address from observers looking at system data because individual name is not output by trusted 3^{rd} party.

In Step 440 trusted 3^{rd} party performs processing for the complete target list outputting any or all client devices/networks for this DM Individual.

In Step 450 trusted 3^{rd} party or any other entity in the ad list generation/ad distribution processing chain resolves addresses to Network/DM devices owned by individual and optionally performs other processing such as duplicate name elimination, or unknown address for DM individual processing. In FIG. 22, optional additional Step 500 describes mapping a DM individual to a subscriber device. Step 510 provides privacy mapping in that targeted devices are output on a list without owner information.

In FIG. 23 the processing shown in FIG. 18 or any other figures includes a list grooming processing 600 such as the elimination of duplicate entries, removal of targets with unknown addresses or who cannot be reached.

In FIG. 24 additional data is associated with this ad delivery system providing viewers methods to obtain more information about the product being advertised, or a link or button to “buy” the product or browse to a website associated with an ad. This is referred to as the user response step 700. As with any of the processing described herein, the logging of subscriber actions associated with FIG. 24 additional data can be logged or monitored.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method of communicating targeted advertising segments, to individual consumers, receiving electronic signals converted locally on a media device for local display comprising:
generating an advertisement adapted for storage in electronic memory, for a particular product or service;
generating an electronic list of said consumers discerned as having interest in a purchase of said particular product or service; and
including in said list, respective consumer identifiers of each respective consumer;
discerning future advertisement time slots which will occur during electronic media program broadcasts, which are communicated by broadcasters to multiple system providers, for a subsequent electronic communication to the electronic media reception devices of individual said consumers who receive said electronic media broadcasts through a connection to a said system provider;
placing said electronic list in electronic memory accessible for communication to respective said media reception devices of each said consumer; and
prior to the occurrence of a said time slot for viewing a said advertisement communicated from said broadcaster, employing software on said media reception device to access said electronic list and to ascertain if a match occurs between a said consumer identifier associated with said consumer media device, and a said consumer identifier on said electronic list;
if a match is ascertained, communicating said advertisement for said particular product or service from said in electronic memory to said consumer media device in place of said advertisement communicated from said broadcaster.

2. The method of claim 1 additionally including:
employing an electronic identifier related solely to said consumer media device as said consumer identifier.

3. The method of claim 2 additionally comprising:
employing one or a plurality of consumer identifiers from a group of identifiers including, an electronic identifier of an electronic device known to be associated with a said consumer, the consumer's name, and the consumer's address.

4. The method of claim 3 additionally comprising:
encrypting said electronic list of said consumers discerned as having interest in a purchase of a particular product or service to render it indecipherable without an electronic key;
providing said electronic key to an escrow agent having electronic access to said electronic system of said system provider;
allowing said escrow agent to employ said key to render said electronic list readable by software running on said consumer media devices; and
communicating access to said electronic list to said media reception device of each said consumer from electronic storage on a computing device controlled by said escrow agent in a mode readable by software running on said consumer media device.

5. The method of claim 4 additionally comprising:
configuring said consumer media device to communicate advertisement information concerning a viewing of said advertisement by a respective said computer; and
having said escrow agent collect all said advertisement information communicated by respective said consumer media devices to denoted parties authorized to receive it.

6. The method of claim 1, additionally comprising:
placing said electronic list into electronic memory of said consumer media device.

7. The method of claim 5, additionally comprising:
placing said electronic list into electronic memory of said consumer media device.
